(19) United States
(12) Patent Application Publication
(10) Pub. No.: US 2005/0286215 A1
(43) Pub. Date: Dec. 29, 2005

(54) Notebook computer

(75) Inventors: Yu-Chun Yang, Kaohsiung City (TW); Kuo-Chang Yang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/073,834

(22) Filed: Mar. 7, 2005

(30) Foreign Application Priority Data
Jun. 23, 2004 (TW) 93118044

(51) Int. Cl. G06F 1/16

(52) U.S. Cl. 361/683; 361/726

(57) ABSTRACT

A notebook computer. A host includes an engaging groove and a first magnet adjacent thereto. A cover structure is rotatably connected to the host, with an actuating member, a second magnet, and an engaging member. The actuating member is movably disposed in the cover structure. The magnetic force of the second magnet is less than that of the first magnet. The engaging member includes magnetic-attractive material and is rotatably disposed in the cover structure. The engaging member is rotated to a first position by pushing the actuating member and is positioned therein by attraction of the second magnet. The engaging member is rotated to a second position by attraction of the first magnet and is engaged in the engaging groove of the host.

### BACKGROUND

The invention relates to a notebook computer, and in particular to a notebook computer with an aesthetically pleasing appearance.

A notebook computer generally includes a cover and a host. A hook structure is conventionally deployed between the cover and the host. For example, a hook can be disposed on the cover comprising an LCD module and a spline can be disposed on the host. The cover and host can be tightly closed by the hook engaging the spline. Nevertheless, the hook structure (or hook) is often exposed. When the notebook computer is opened, the exposed hook structure (or hook) adversely affects appearance thereof.

Hence, there is a need to provide a notebook computer with an aesthetically pleasing appearance.

### SUMMARY

Accordingly, a notebook computer of an embodiment of the invention comprises a host and a cover structure. The host includes an engaging groove and a first magnet adjacent thereto. The cover structure is rotatably connected to the host, with an actuating member, a second magnet, and an engaging member. The actuating member is movably disposed in the cover structure. The magnetic force of the second magnet is less than that of the first magnet. The engaging member includes magnetic-attractive material and is rotatably disposed in the cover structure. The engaging member is rotated to a first position by pushing the actuating member and is positioned therein by attraction of the second magnet. The engaging member is rotated to a second position by attraction of the first magnet and is engaged in the engaging groove of the host.

The notebook computer further comprises a support member and a resilient member. The support member is disposed in the cover structure and the resilient member is connected between the actuating member and the support member.

The resilient member comprises a spring.

The cover structure further comprises a housing. The second magnet and support member are disposed on the housing. The engaging member is rotatably connected to the housing.

The housing further comprises a through hole in which the actuating member is movably disposed.

The engaging member further comprises a retardant portion and an engaging portion. The retardant portion abuts the support member when the engaging member is rotated to the first position by pushing the actuating member. The engaging portion is engaged in the engaging groove when the engaging member is rotated to a second position by attraction of the first magnet.

The second magnet is adjacent to the actuating member.

The notebook computer further comprises an LCD module disposed in the cover structure.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic top view of the notebook computer of an embodiment of the invention;

FIG. 2 is a schematic cross section taken along line A-A of FIG. 1;

FIG. 3A is a partial enlarged view according to FIG. 2;

FIG. 3B is a partial perspective view of a cover structure according to FIG. 3A;

FIG. 4 is a partial cross section showing operation of the notebook computer of an embodiment of the invention;

FIG. 5A is another partial cross section showing operation of the notebook computer of an embodiment of the invention; and

FIG. 5B is a partial perspective view of a cover structure according to FIG. 5A.

### DETAILED DESCRIPTION

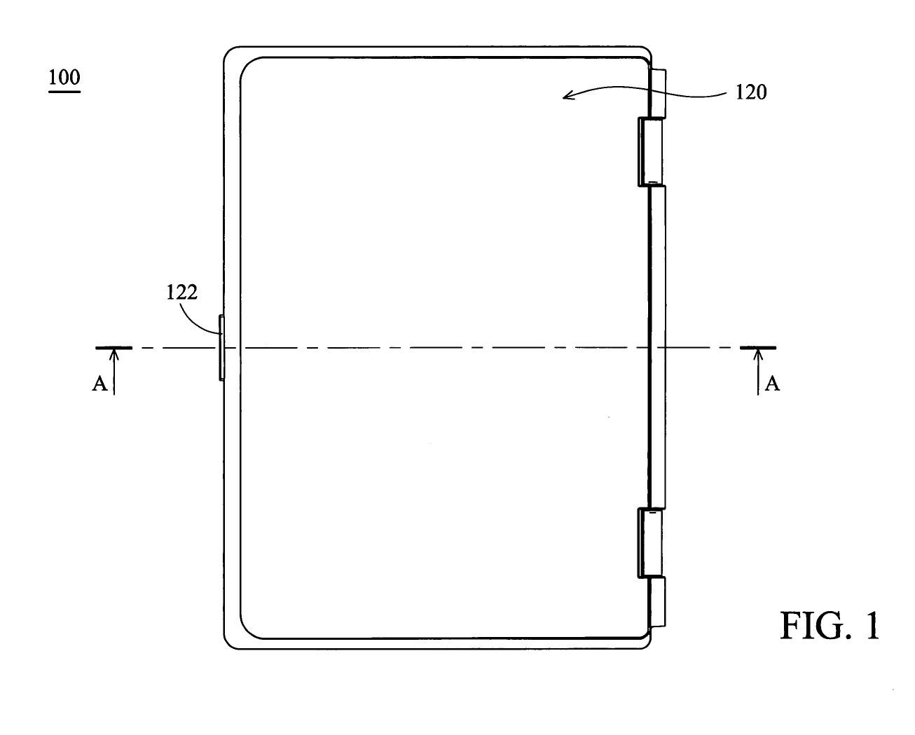

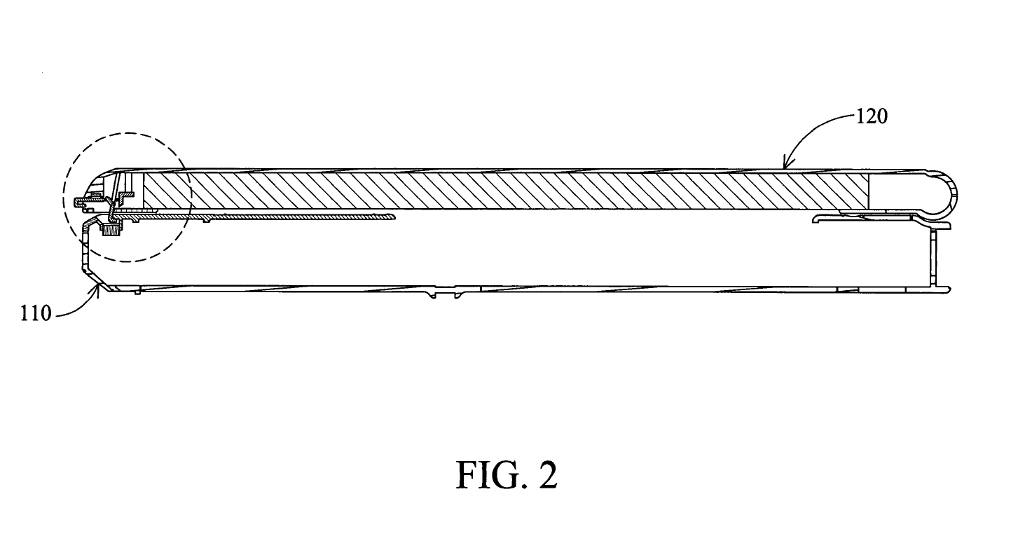

Referring to FIGS. 1, 2, and 3A, the notebook computer (electronic device) 100 comprises a host (first body) 110 and a cover structure (second body) 120 rotatably connected thereto.

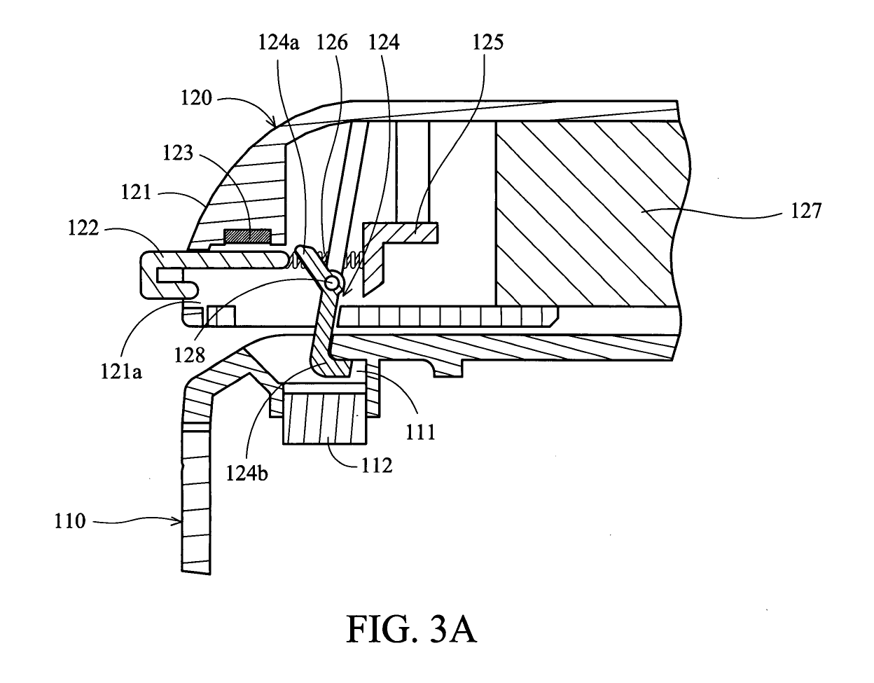

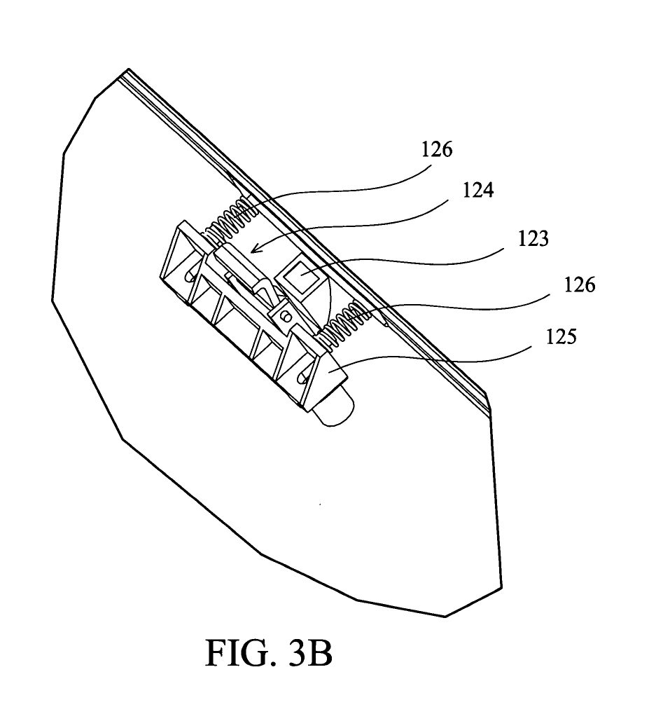

As shown in FIGS. 3A, 4, and 5A, the host 110 comprises an engaging groove 111 and a first magnet 112 adjacent thereto.

The cover structure 120 comprises a housing 121, an actuating member 122, a second magnet 123, an engaging member 124, a support member 125, a resilient member 126, and an LCD module 127.

The actuating member 122 is movably disposed in the cover structure 120. Specifically, the housing 121 comprises a through hole 121a in which the actuating member 122 is movably disposed. Namely, the actuating member 122 can move into and out of the housing 121 of the cover structure 120 via the through-hole 121a.

The second magnet 123 is adjacent to the actuating member 122 and is disposed on the housing 121. Specifically, the magnetic force of the second magnet 123 is far less than that of the first magnet 112.

The engaging member 124 comprises magnetic-attractive material which can be attracted by magnets, rotatably disposed in the cover structure 120. Specifically, the engaging member 124 is rotatably connected to the housing 121 of the cover structure 120. Additionally, the engaging member 124 comprises a retardant portion 124a and an engaging portion 124b.

The support member 125 is disposed in the cover structure 120. Specifically, the support member 125 is fixed on the housing 121 of the cover structure 120.

The resilient member 126 is connected between the actuating member 122 and the support member 125. In this embodiment, the resilient member 126 is a spring.

The LCD module 127 is disposed in the cover structure 120.

The following description is directed to operation of the notebook computer (electronic device) 100.

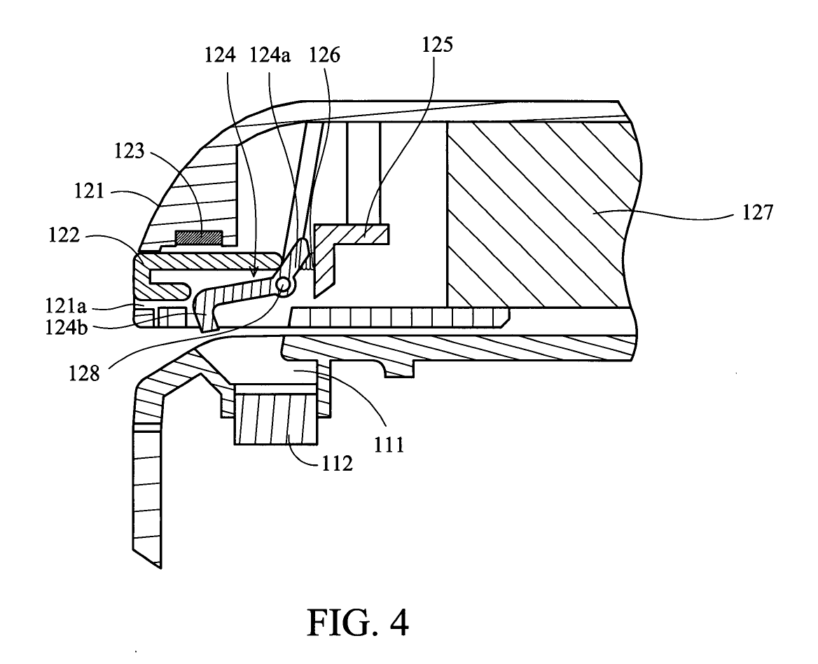

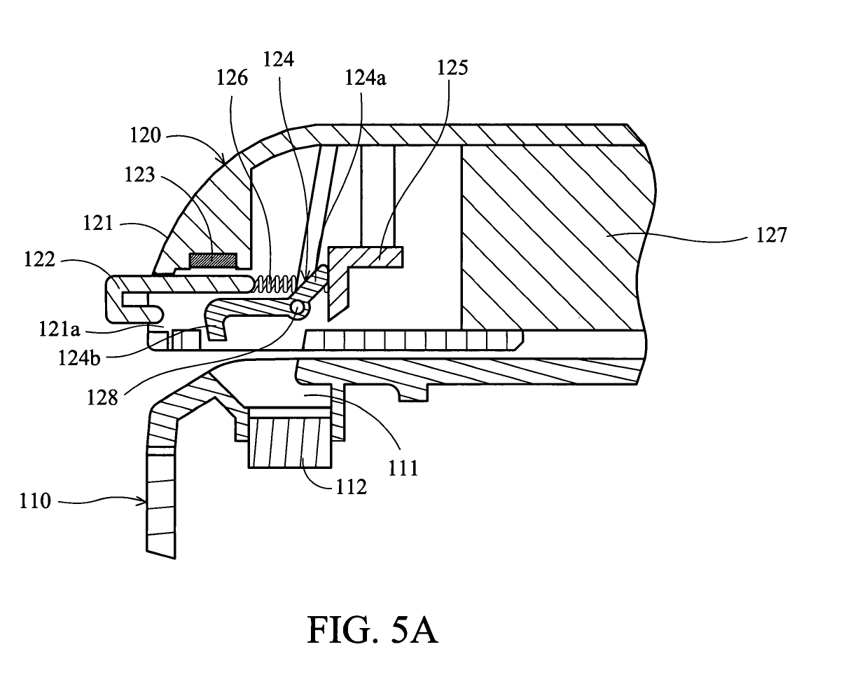

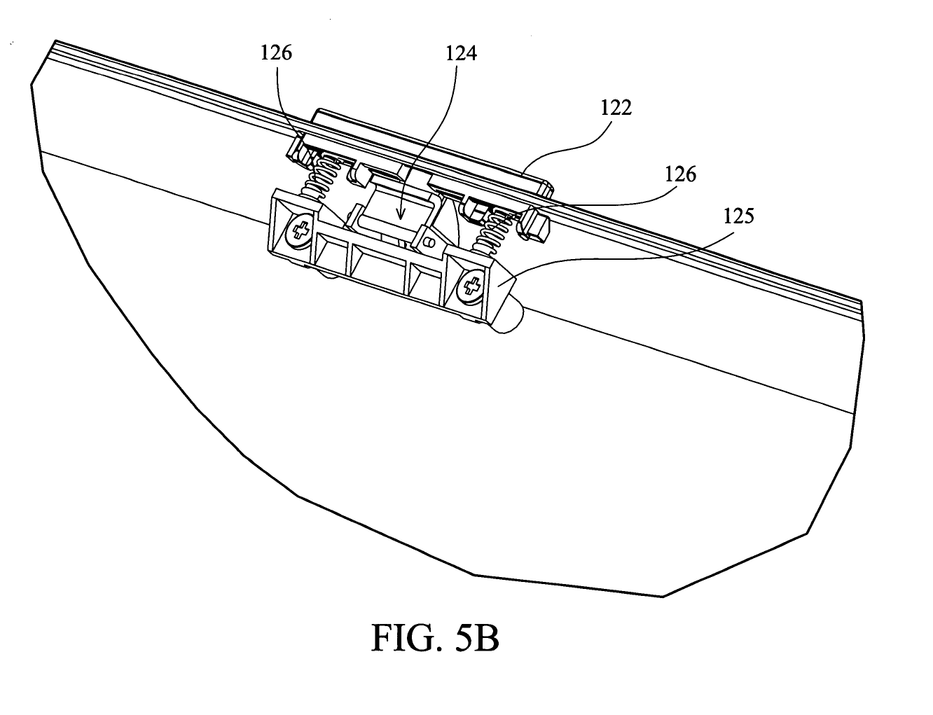

As shown in FIG. 3A and FIG. 3B, when the host (first body) 110 and cover structure (second body) 120 of the notebook computer 100 close, the engaging member 124 disposed in the cover structure 120 rotates to a second position by attraction of the first magnet 112 disposed in the host 110. At this point, the engaging portion 124b of the engaging member 124 is engaged in the engaging groove 111 of the host 110, securing the cover structure 120 on the host 110. When the cover structure 120 is rotatably separated from the host 110, the actuating member 122 can be pushed from the exterior of the cover structure 120 such that the actuating member 122 pushes the retardant portion 124a of the engaging member 124. At this point, the engaging member 124 rotates clockwise around a rotating shaft 128 by pushing the actuating member 122. As shown in FIG. 4, the resilient member 126 connected between the actuating member 122 and the support member 125 is compressed. The actuating member 122 continues to push the retardant portion 124a of the engaging member 124 until the retardant portion 124a abuts the support member 125. At this point, the engaging member 124 is rotated to a first position and compression of the resilient member 126 is maximum. Since the engaging portion 124b of the engaging member 124 is completely separated from the engaging groove 111 of the host 110, the cover structure 120 can be simultaneously rotated to rotatably separate from the host 110. As shown in FIG. 5A and FIG. 5B, the engaging member 124 is then positioned in the first position (or hidden in the cover structure 120) by attraction of the second magnet 123. At this point, the actuating member 122 is no longer pushed and can return to its original position by resilience provided by the resilient member 126.

In another aspect, when the host 110 and cover structure 120 close, the cover structure 120 is rotated onto the host 110, as shown in FIG. 5A. At this point, since the magnetic force of the second magnet 123 is far less than that of the first magnet 112, the engaging member 124 disposed in the cover structure 120 immediately rotates counterclockwise to the second position by attraction of the first magnet 112 and the engaging portion 124b of the engaging member 124 is again engaged in the engaging groove 111 of the host 110, securing the cover structure 120 on the host 110, as shown in FIG. 3A.

Accordingly, when the notebook computer (electronic device) 100 is opened, the hook (hook structure) is not exposed on the cover structure 120 or host 110. Thus, the notebook computer (electronic device) 100 can present an aesthetically pleasing appearance. Moreover, engagement operation between the cover structure 120 and the host 110 of the notebook computer (electronic device) 100 is simplified.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A notebook computer, comprising:
a host, with an engaging groove and a first magnet adjacent thereto; and
a cover structure rotatably connected to the host, with an actuating member, a second magnet, and an engaging member, wherein the actuating member is movably disposed in the cover structure, the magnetic force of the second magnet is less than that of the first magnet, and the engaging member comprises magnetic-attractive material and is rotatably disposed in the cover structure,
whereby the engaging member is rotated to a first position by pushing the actuating member and is positioned therein by attraction of the second magnet,
whereby the engaging member is rotated to a second position by attraction of the first magnet and is engaged in the engaging groove of the host.

2. The notebook computer as claimed in claim 1, further comprising a support member and a resilient member, wherein the support member is disposed in the cover structure and the resilient member is connected between the actuating member and the support member.

3. The notebook computer as claimed in claim 2, wherein the resilient member comprises a spring.

4. The notebook computer as claimed in claim 2, wherein the cover structure further comprises a housing, the second magnet and support member are disposed on the housing, and the engaging member is rotatably connected to the housing.

5. The notebook computer as claimed in claim 4, wherein the housing further comprises a through hole in which the actuating member is movably disposed.

6. The notebook computer as claimed in claim 2, wherein the engaging member further comprises a retardant portion and an engaging portion, the retardant portion abuts the support member when the engaging member is rotated to the first position by pushing the actuating member, and the engaging portion is engaged in the engaging groove when the engaging member is rotated to a second position by attraction of the first magnet.

7. The notebook computer as claimed in claim 1, wherein the second magnet is adjacent to the actuating member.

8. The notebook computer as claimed in claim 1, further comprising an LCD module deployed in the cover structure.

9. An electronic device, comprising:
a first body, with an engaging groove and a first magnet adjacent thereto; and
a second body rotatably connected to the first body, with an actuating member, a second magnet, and an engaging member, wherein the actuating member is movably disposed in the second body, the magnetic force of the second magnet is less than that of the first magnet, and the engaging member comprises magnetic-attractive material and is rotatably disposed in the second body,
whereby the engaging member is rotated to a first position by pushing the actuating member and is positioned therein by attraction of the second magnet,
whereby the engaging member is rotated to a second position by attraction of the first magnet and is engaged in the engaging groove of the first body.

10. The electronic device as claimed in claim 9, further comprising a support member and a resilient member, wherein the support member is disposed in the second body and the resilient member is connected between the actuating member and the support member.

11. The electronic device as claimed in claim 10, wherein the resilient member comprises a spring.

12. The electronic device as claimed in claim 10, wherein the second body further comprises a housing, the second magnet and support member are disposed on the housing, and the engaging member is rotatably connected to the housing.

13. The electronic device as claimed in claim 12, wherein the housing further comprises a through hole in which the actuating member is movably disposed.

14. The electronic device as claimed in claim 10, wherein the engaging member further comprises a retardant portion and an engaging portion, the retardant portion abuts the support member when the engaging member is rotated to the first position by pushing the actuating member, and the engaging portion is engaged in the engaging groove when the engaging member is rotated to a second position by attraction of the first magnet.

15. The electronic device as claimed in claim 9, wherein the second magnet is adjacent to the actuating member.
